(19) United States
(12) Patent Application Publication
(10) Pub. No.: US 2012/0111366 A1
(43) Pub. Date: May 10, 2012

(54) APPLIANCE WITH HANDLE INTERFACE

(75) Inventors: MARK W. BALDWIN, ST. JOSEPH, MI (US); BALAKRISHNA CHENNUPATI, ST. JOSEPH, MI (US); REXFORD W. CORDILL, GRANGER, IN (US); SUJIT SURESH NAIK, PUNE (IN)

(73) Assignee: WHIRLPOOL CORPORATION, BENTON HARBOR, MI (US)

(21) Appl. No.: 12/940,124

(22) Filed: Nov. 5, 2010

(51) Int. Cl. A47L 15/42; E05B 65/08; E05B 3/00

(52) U.S. Cl. 134/18; 312/228

(57) ABSTRACT

An appliance having a handle for grasping and moving a movable element of the appliance, with a user interface mounted to the handle.

### BACKGROUND OF THE INVENTION

Contemporary appliances, an example of which includes automatic dishwashers, often have a door or other moveable element on which a handle is provided for a user to grasp in moving the moveable element. The presence of the handle, while beneficial for moving the moveable element, presents many design problems. One of which is that the handle often takes up useful surface area on the appliance that would otherwise be available for use in other ways, such as the location for the placement of a user interface for the appliance.

### SUMMARY OF THE INVENTION

The invention relates to an appliance having a handle pivotally movable relative to the door and a user interface mounted to the handle and viewable by a user when the handle is in an unlatched position.

### BRIEF DESCRIPTION OF THE DRAWINGS

In the drawings:

FIG. 1 is a schematic, cross-sectional view of a dishwasher according to a first embodiment of the invention.

FIG. 2 is a perspective view of a door of the dishwasher shown in FIG. 1 having a handle in a latched position.

FIG. 3 is a cross-sectional view of a portion of the dishwasher of FIG. 1 and illustrating a latch assembly according to a second embodiment of the invention in a latched position.

FIGS. 4A-4B are rear perspective views of the latch assembly illustrated in FIG. 3.

FIG. 5 is a schematic, cross-sectional view of the dishwasher shown in FIG. 1 having the door slightly ajar and the handle rotated to a use position.

FIG. 6 is a perspective view of the door of the dishwasher shown in FIG. 5 having the handle rotated to a use position.

FIG. 7 is a cross-sectional view of the portion of the dishwasher illustrated in FIG. 3 with the latch assembly rotated to a use position.

FIGS. 8A-8C are side views of the latch assembly illustrated in FIG. 3 and show the pivot motion of the handle.

FIG. 9 is a close up of a portion of a latch assembly according to a third embodiment of the invention.

FIGS. 10A-10C are schematic illustrations of the pivot motion of the different portions of the latch assembly illustrated in FIG. 8.

FIG. 11 is a front view of a user interface of the dishwasher of FIG. 1.

FIG. 12 is a front view of a user interface of the dishwasher of FIG. 1.

FIG. 13 is a perspective view of a portion of the door of the dishwasher shown in FIG. 1 having a latch assembly according to a fourth embodiment of the invention.

### DESCRIPTION OF EMBODIMENTS OF THE INVENTION

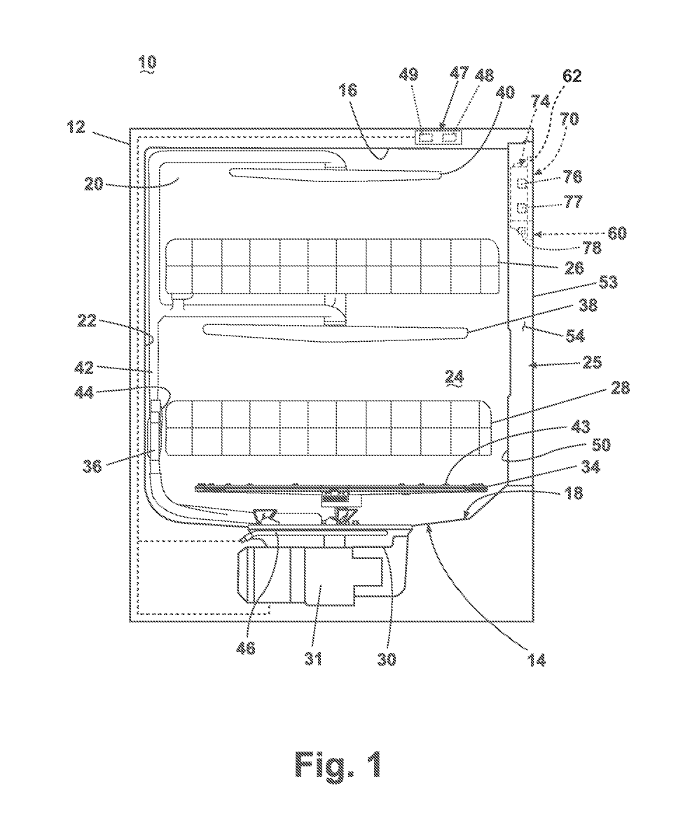

In FIG. 1, a first embodiment of the invention is illustrated in the environment of an automated dishwasher 10 having a chassis 12. The chassis 12 defines an interior and may be a frame with or without panels mounted to the frame. The dishwasher 10 shares many features of a conventional automated dishwasher, which will not be described in detail herein except as necessary for a complete understanding of the invention. The chassis 12 houses an open-faced wash tub 14 having spaced top and bottom walls 16 and 18, spaced sidewalls 20, and a rear wall 22. The walls 16, 18, 20, and 22 collectively define a treating chamber 24, having an open face, for washing utensils. A door assembly 25 may be movably mounted to the dishwasher 10 for movement between opened and closed positions to selectively open and close the open face of the wash tub 14. Thus, the door assembly provides accessibility to the treating chamber 24 for the loading and unloading dishes or other washable items.

It should be appreciated that the door assembly 25 may be secured to the lower front edge of the chassis 12 or to the lower front edge of the wash tub 14 via a hinge assembly (not shown) configured to pivot the door assembly 25. When the door assembly 25 is closed, user access to the treating chamber 24 is prevented, whereas user access to the treating chamber 24 is permitted when the door assembly 25 is open.

The dishwasher 10 is also illustrated as including a latch assembly 60 mounted to the door assembly 25. Where the latch assembly 60 has a handle 62 pivotally movable relative to the door assembly 25 and a user interface 70 is mounted to the handle 62. The latch assembly 60 may be used to open the door assembly 25 and the user interface 70 located on the latch assembly 60 may enable the user to select the desired wash cycle and set correspondingly relevant parameters or options for the wash cycle.

Utensil holders, illustrated in the form of upper and lower utensil racks 26, 28, are located within the treating chamber 24 and receive dishes for washing. The upper and lower racks 26, 28 are typically mounted for slidable movement in and out of the treating chamber 24 for ease of loading and unloading. Other utensil holders may be provided, such as a silverware basket. As used in this description, the term “utensil(s)” is intended to be generic to any item, single or plural, that may be treated in the dishwasher 10, including, without limitation; dishes, plates, pots, bowls, pans, glassware, and silverware. While the present invention is described in terms of a conventional dishwashing unit as illustrated in FIG. 1, it could also be implemented in other types of dishwashing units such as in-sink dishwashers or drawer dishwashers including drawer dishwashers having multiple compartments.

A sump 30 may be provided in the tub, such as by sloping the bottom wall 18 of the dishwasher 10. A pump assembly 31 may be located in or around a portion of the bottom wall 18 and in fluid communication with the sump 30 to draw wash liquid from the sump 30 and to pump the liquid to at least a first lower spray assembly 34 and a second lower spray assembly 36. If the dishwasher has a rotating mid-level spray arm assembly 38 and/or an upper spray arm assembly 40, as illustrated herein, liquid may be simultaneously or selectively pumped through a supply tube 42 to each of the assemblies 38, 40 for selective spraying.

As illustrated, the first lower spray assembly 34 is positioned beneath the lower utensil rack 28. The first lower spray assembly 34 is an arm configured to rotate in the wash tub 14 and spray a flow of liquid from at least one outlet 43, in a primarily upward direction, over a portion of the interior of the wash tub 14. A first wash zone may be defined by the spray field emitted by the first lower spray assembly 34 into the treating chamber 24. The spray from the first lower spray assembly 34 is typically directed to wash utensils located in the lower utensil rack 28. The first lower spray assembly 34 may optionally also provide a liquid spray downwardly onto the lower tub region 29, but for purposes of simplification, this will not be illustrated or described herein.

The second lower spray assembly 36 is illustrated as being located adjacent the lower utensil rack 28 toward the rear of the treating chamber 24. The second lower spray assembly 36 is illustrated as including a vertically oriented distribution header or spray manifold 44. The spray manifold 44 may not be limited to this position; rather, the spray manifold 44 could be located in virtually any part of the treating chamber 24. Alternatively, the manifold 44 could be positioned underneath the lower rack 28, adjacent or beneath the first lower spray assembly 34. Such a spray manifold is set forth in detail in U.S. Pat. No. 7,594,513, issued Sep. 29, 2009, and titled “Multiple Wash Zone Dishwasher,” which is incorporated herein by reference in its entirety.

The second lower spray assembly 36 may be configured to spray a flow of treating liquid from the spray manifold 44, in a generally lateral direction, over a portion of the interior of the treating chamber 24. The spray from the spray manifold 44 may be typically directed to treat utensils located in the lower rack 28. A second wash zone may be defined by the spray field emitted by the second lower spray assembly 36 into the treating chamber 24. When both the first lower spray assembly 34 and the second lower spray assembly 36 emit spray fields the first and second zones may intersect.

As illustrated, the mid-level spray arm assembly 38 is positioned between the upper utensil rack 26 and the lower utensil rack 28. Like the first lower spray assembly 34, the mid-level spray arm assembly 38 may also be configured to rotate in the dishwasher 10 and spray a flow of liquid from at least one outlet 43, in a generally upward direction, over a portion of the interior of the wash tub 14. In this case, the spray from the mid-level spray arm assembly 38 is directed to utensils in the upper utensil rack 26. In contrast, the upper spray arm assembly 40 is positioned above the upper utensil rack 26 and generally directs a spray of liquid in a generally downward direction and helps wash utensils on both upper and lower utensil racks 26, 28. The liquid may be water, a wash aid, or any combination there of. Examples of common wash aids include: a detergent, a spot reducer, a rinse agent, a stain remover, bleach, or any other similar product that facilitates excellent cleaning of the utensils.

The spray assemblies 34-40 depicted and described herein are for illustrative purposes only, and are not meant to limit the disclosure in any way. It has been contemplated that the spray assemblies 34-40 may be of any structure and configuration. For example, the dishwasher 10 may include other sprayer configurations such as a sprayer assembly movable in a generally vertical plane, a translating wash arm, a discrete nozzle-type sprayer, or an array of wall-mounted nozzle-type sprayers. These may all be individually controllable, or controllable in selected groups, to deliver a spray of wash liquid to selected areas of the treating chamber.

The pump assembly 31, spray assemblies 34-40 and supply tube 42 collectively form a liquid recirculation system for spray liquid within the treating chamber 24. The pump draws liquid from the sump 30 and delivers it to one or more of the spray assemblies 34-40 through the supply tube 42, where the liquid is sprayed back into the treating chamber 24 through the spray assemblies 34-40 and drains back to the sump 30 where the process is repeated.

A heater 46 may be located within the sump for heating the water contained in the sump. A main controller 47 (shown in phantom) may be operably coupled with one or more components of the dishwasher 10 for communicating with and controlling the operation of the components to complete a cycle of operation. For example, the main controller 47 may be coupled with heater 46 for heating the wash liquid during a cycle of operation, the pump assembly 31 and the spray assemblies 34-40 for recirculating the wash liquid during the cycle of operation, and any dispensing systems (not shown for clarity) for dispensing treating chemistry or rinse aids and water to the treating chamber 24 during a cycle of operation.

As illustrated schematically in phantom in FIG. 1, the main controller 47 may be provided with a memory 48 and a central processing unit (CPU) 49. The main controller may be located somewhere with the chassis 12 as illustrated, or it may alternatively be located within the door assembly 25. The memory 48 may be used for storing control software that may be executed by the CPU 49 in completing a cycle of operation using the dishwasher 10 and any additional software. For example, the memory 48 may store one or more pre-programmed cycles of operation that may be selected by a user and completed by the dishwasher 10. The main controller 47 may also be operably coupled with the user interface 70 and a secondary controller 74 associated with the user interface 70 for receiving user-selected inputs and communicating information to the user. The main controller 47 may be operably coupled to the user interface 70 through the secondary controller 74. The secondary controller 74 may electronically couple, wired or wirelessly with the main controller 74. The memory 48 may also be used to store information, such as a database or table, and to store data received from one or more components of the dishwasher 10 that may be communicably coupled with the main controller 47.

The main controller 47 may also receive input from one or more sensors, which are known in the art and not shown for simplicity. Non-limiting examples of sensors that may be communicably coupled with the main controller 47 include a temperature sensor, turbidity sensor to determine the soil load associated with a selected grouping of utensils, such as the utensils associated with a particular area of the treating chamber and a sensor for determining a load value at selected locations within the dishwasher 10. The load value may be reflective of either or both a utensil load, i.e. the number and/or size of the utensils in the dishwasher, and/or a soil load, i.e. the quantity of soil on the utensils.

The main controller 47 may control the components of the dishwasher 10 to complete a cycle of operation stored in the controller memory 48 based on a setting of one or more operating parameters. The operating parameters may correspond, for example, to a type of utensil, a soil level, or an amount of utensils in the load. The operating parameters may be set to control the components of the dishwasher 10 to provide the recommended utensil care for the selected cycle of operation. The operating parameters may be set automatically by the main controller 47 when the user selects one of the pre-programmed cycles of operation.

Alternatively, one or more of the operating parameters may be set by the user via the user interface 70 to modify one of the pre-programmed cycles of operation according to the user's preferences. For example, the user may select a zone within the treating chamber and then manually set a cleaning cycle for that zone, which may be different than the default wash cycle for the rest of the dishwasher. This information may be relayed from the user interface 70 to the secondary controller 74 where it then may be relayed to the main controller 47.

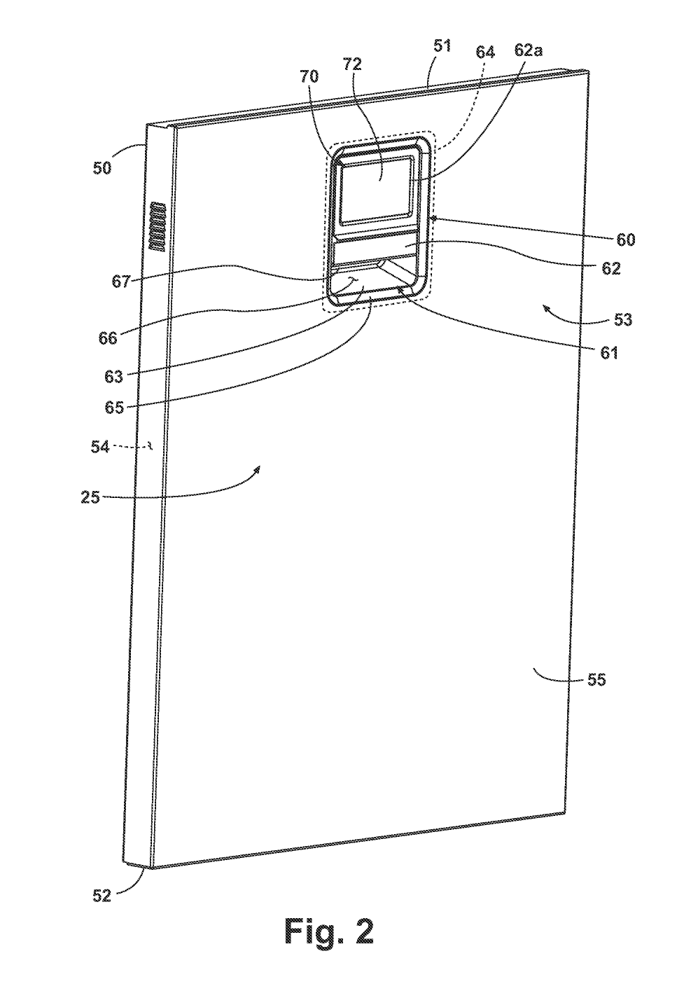

The user interface 70 may include operational controls such as dials, lights, switches, and displays enabling a user to input commands to the secondary controller 74 and receive information about the selected cleaning cycle and operating parameters. To facilitate such selections, the user interface 70 may include a touch-sensitive display or touch screen 72 for receiving input from a user and displaying output to the user. The touch screen 72 may be any suitable type of touch screen display, such as a liquid crystal display (LCD) or light emitting polymer display (LPD). Non-limiting examples of suitable touch sensing technologies that may be used with the touch screen 72 include capacitive, resistive, infrared, pressure, and surface acoustic waves. The touch screen 72 illustrated in FIG. 2 is a non-limiting example of an LCD touch screen.

More specifically, the secondary controller 74 may receive user-selected inputs and may communicate information to the user. The secondary controller 74 may be mounted to an obverse side of the handle 62 from the user interface 70. As illustrated in phantom in FIG. 1, the secondary controller 74 may be provided with a memory 76 and a central processing unit (CPU) 77. The memory 76 may be used for storing control software that may be executed by the CPU 77. For example, the memory 76 may store one or more pre-programmed cycles of operation that may be selected by a user. The memory 76 may also be used to store information, such as a database or table, and to store data received from one or more components of the dishwasher 10 that may be communicably coupled with the secondary controller 74.

The secondary controller 74 may receive input from one or more sensors, which are known in the art and not shown for simplicity. Non-limiting examples of sensors that may be communicably coupled with the secondary controller 74 include a position sensor 78 for communication at least one position of the handle 62, such as the use position, to the secondary controller 74. Alternatively, it has been contemplated that the position sensor 78 may communicate multiple positions of the handle 62 to the secondary controller 74. In this manner, the secondary controller 74 may receive input regarding the rotational position of the user interface 70 and may operate the user interface 70 accordingly.

FIG. 2 illustrates in more detail, the door assembly 25 of the dishwasher 10. An inner door panel 50 extends downwardly from an upper end 51 of the door assembly 25 to a lower end 52. An outer door panel 53 extends downwardly from the upper end 51 of the door assembly 25. When the door assembly 25 is opened, the outer door panel 53 tips outwardly along with the inner door panel 50.

A bezel 61 defines an opening in the outer panel through which the user interface 70 is accessible. The bezel 61 may be received in the opening formed in the outer door panel 53. The bezel 61 may be secured to the door assembly 25 via a screw or other fastener (not shown). It may be seen that the bezel 61 also includes an inner flange 64 that contacts the outer door panel 53. A front end 65 of the housing 63 is flush with the front wall 55 of the outer door panel 53. It will be appreciated that in other embodiments the inner flange may be removed and another flange may be added, which extends outwardly from the front end 65 and contacts the outer surface of the front wall 55 of the outer door panel 50. The housing 63 has a pocket 66 defined therein that extends rearwardly from the front end 65 of the housing 63 to a back surface 67 of the housing 63.

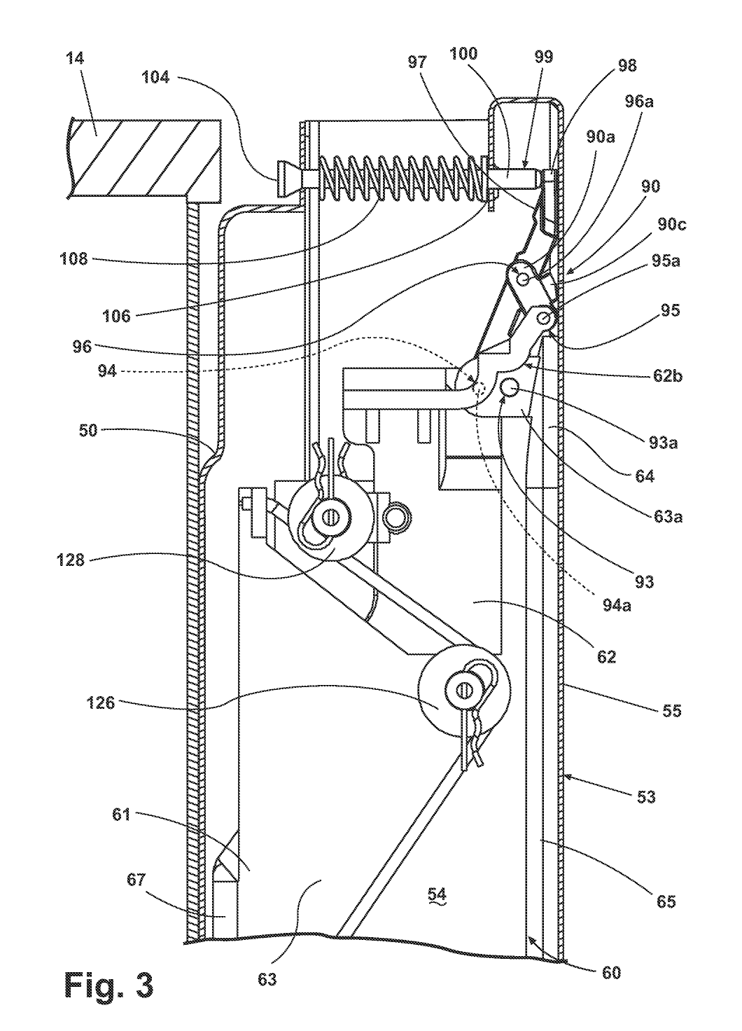

Referring to FIG. 3, the outer door panel 53 is spaced apart from the inner door panel 50 such that a door compartment 54 is defined therebetween. The outer door panel 53 includes an exterior face or front wall 55 that faces outward from the front of the dishwasher 10. The outer door panel 53 has an opening that opens into the door compartment 54.

A latch assembly 60 may be mounted to the door assembly 25 and is operable to move the door through various positions. The latch assembly 60 may be mounted to the door assembly 25 and more specifically, may be received in the opening formed in the outer door panel 53. The latch assembly 60 includes a handle 62, an arm 97, a rotational reducer or multi-pivot linkage 90, and a push rod 99. As illustrated, the arms 97, multi-pivot linkage 90, and push rods 99 are arranged in two sets. Only one of the sets will be described with it being understood the description applies to both sets.

An overview of the operation of the latch assembly 60 will be beneficial prior to a review of the details of the latch assembly. The handle 62 is pivotally mounted to the bezel 61, with the arms 97 pivotally mounted to both the handle 62 and the multi-pivot linkage 90, such that rotation of the handle 62 effects the rotation of the arms 97, with the multi-pivot linkage 90 reducing the degree of rotation of the arms 97 relative to the handle 62. The rotation of the arms 97 extends the push rods 99 to rotate the door assembly 25 from a closed to an opened position.

The parts of the latch assembly 60 will now be described in greater detail. The handle 62 may be rotatably mounted to the housing 63 of the bezel 61 and may be located within the pocket 66. The handle 62 may carry the user interface 70. The user interface 70 may define a normal plane that is substantially parallel with the front wall 55 of the outer door panel 53.

The arms 97 are positioned within the door compartment 54 between the inner door panel 50 and the outer door panel 53 and are coupled to the housing 63. Each of the arms 97 include a tip 98 positioned above the housing 63 of the bezel 61. When the arms 97 are rotated the tips 98 contact the push rods 99. The push rods 99 include a shaft 100 terminating in an end 104 extending through an opening formed in the inner door panel 50 such that the end 104 of each of the push rods 99 is positioned outside of the door compartment 54. A coil spring 108 receives the shaft and abuts a tab 106 coupled to the shaft 100 to bias the shaft 100 into the door compartment 54.

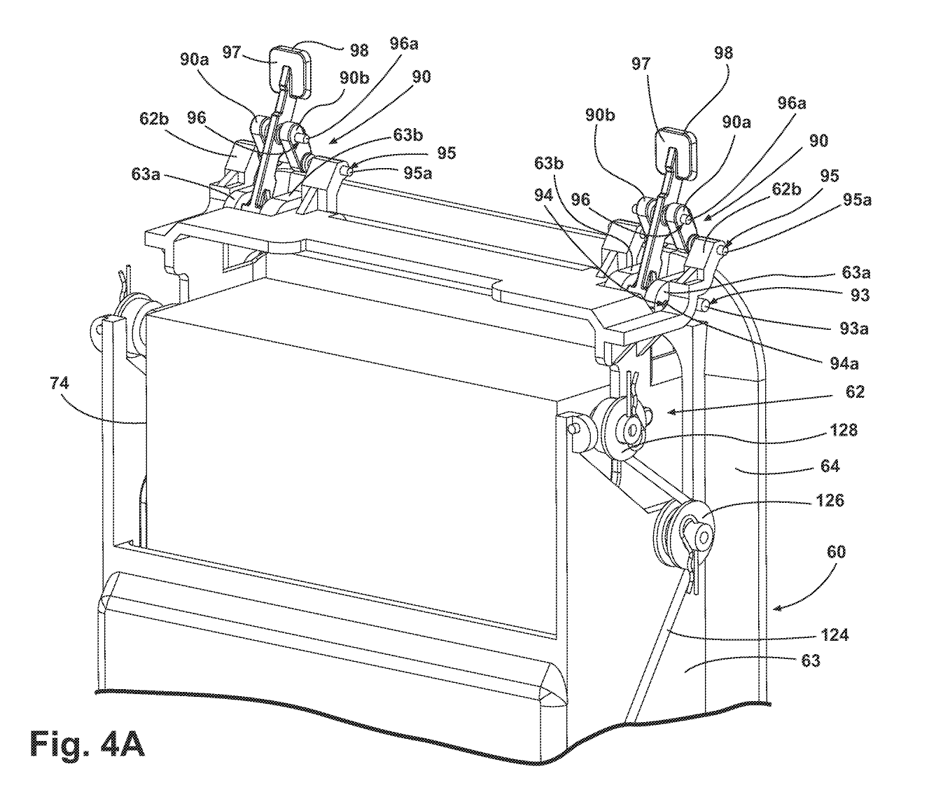

The multi-pivot linkage 90 is best seen in FIG. 4A and forms a rotation reducer that reduces the rotation of the arms 97 relative to the handle 62 thereby permitting a greater rotation of the handle 62 while limiting the rotation of the arms 97 to the available space in the door compartment 54. The multi-pivot linkage 90 includes a pair of handle bars 62a and 62b, projecting as fingers from the handle 62, a pair of housing bars 63a and 63b, projecting as fingers from the housing 63, and linking bars 90a and 90b, coupling the handle bars 62a, 62b to the arms 97.

While the handle bars 62a and 62b are illustrated as integrated with the handle 62, it should be appreciated that these integrally formed parts may alternatively be separate parts operably coupled to the handle 62. The same is true for the integration/non-integration of the housing couplers 63a and 63b with the housing 63. Further, while the linking bars 90a and 90b are illustrated as two pieces connected together by a connector 90c they could be entirely separate pieces.

Referring to FIG. 4B, a pivot joint 93 rotationally couples the handle 62 to the housing bars 63a and 63b by a pivot pin 93a passing through aligned openings in the arm 97 and housing bars 63a, 63b, which defines a corresponding axis of rotation 93c for the handle 62.

Similarly, a pivot joint 94 rotationally couples the arm 97 to the housing bars 63a and 63b by a pivot pin 94a passing through aligned openings in the arm 97 and housing bars 63a, 63b, which defines a corresponding axis of rotation 94c for a lower portion of the arm 97.

Pivot joint 95 rotationally couples the linking bars 90a, 90b to the handle bars 62b, 62c by a pivot pin 95a, which defines a corresponding axis of rotation 95c. Pivot joint 96 rotationally couples the arm 97 and linking bars 90a, 90b by a pivot pin 96a, which defines a corresponding axis of rotation 96c.

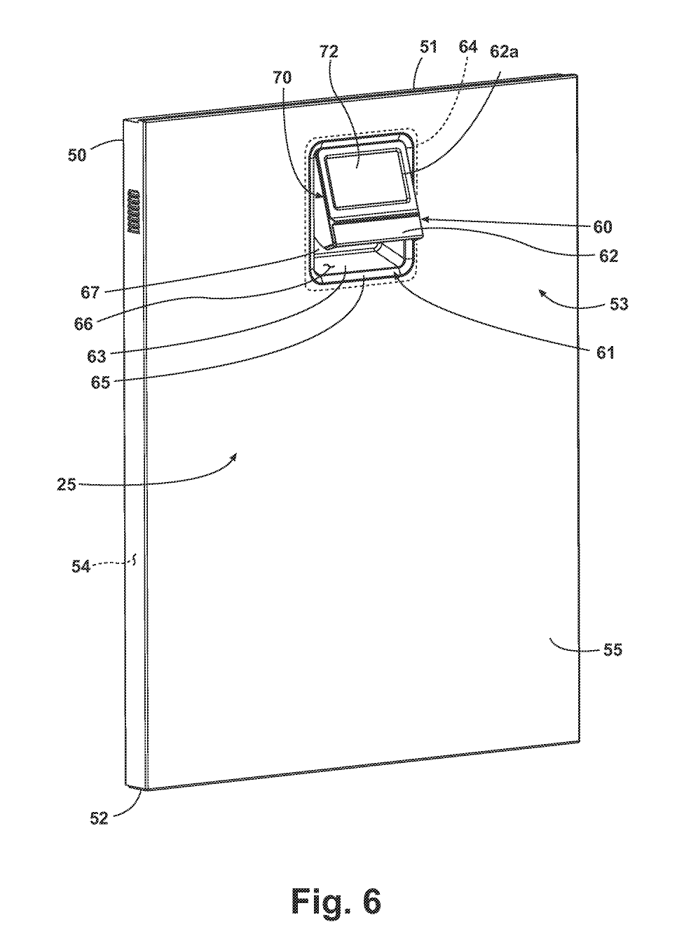

Referring to FIG. 7, a handle position holder in the form of an over-center device 120 is provided. The over-center device 120 is illustrated as an extension spring 122, a nylon cable 124, a series of support rollers 126, and a roller cam 128. The roller cam 128 is operably coupled to the handle 62 and is in contact with the cable 124. The tension provided by the cable 124 and spring 122 allow the handle 62 to have an over-center capability that moves or holds the handle 62. It has been contemplated that alternative over-center devices may be used in the latch assembly 60.

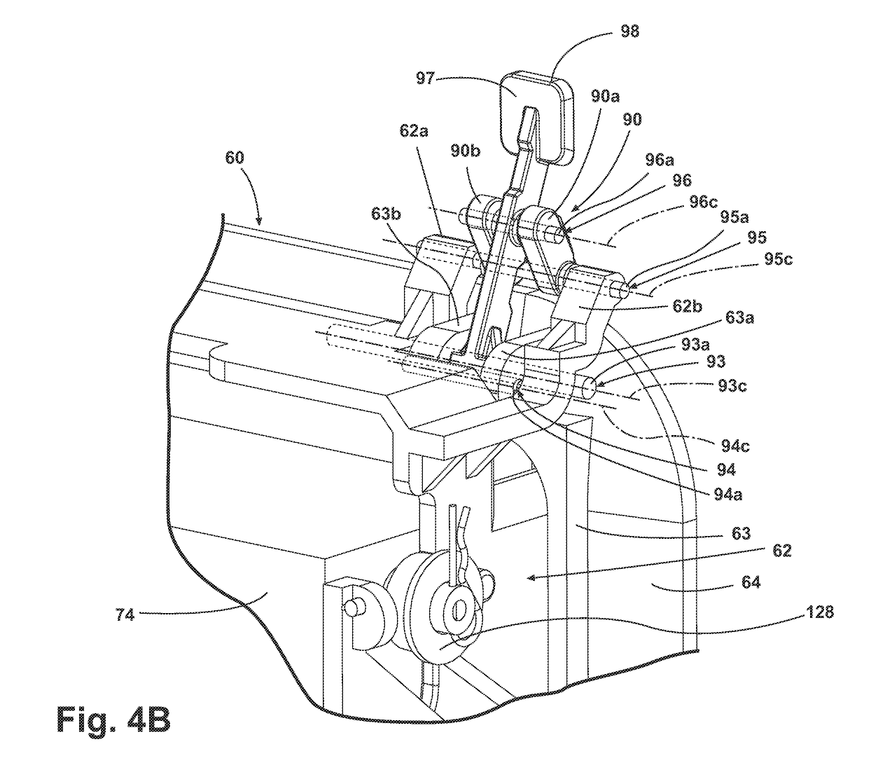

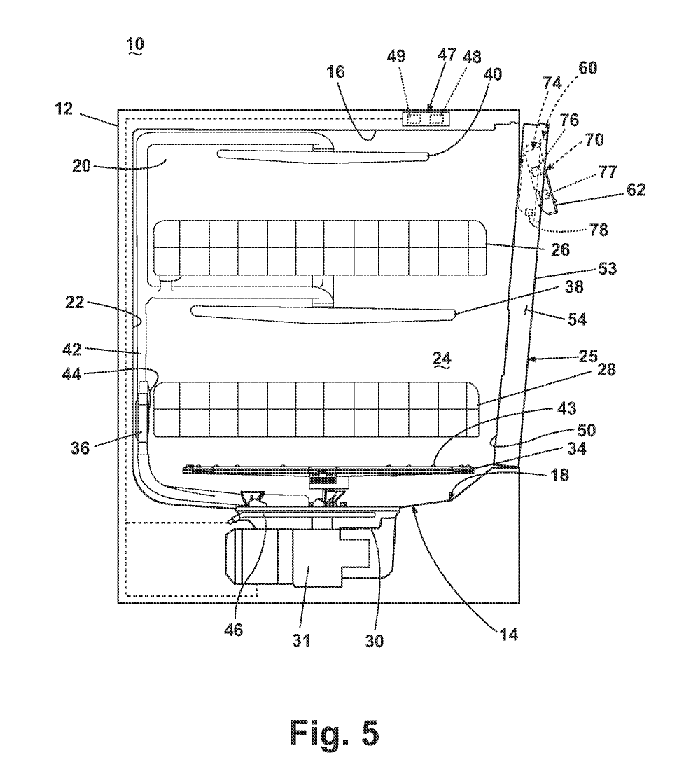

The operation of the latch assembly 60 and door assembly 25 may be started with brief reference to FIGS. 1-4, which have thus far illustrated the handle 62 of the latch assembly 60 in an un-rotated/latched position (also referred to as a stored position or first position) and the door assembly 25 in a closed position. In the latched position, the user interface 70 is flush with the front wall 55 of the door assembly 25. From this latched position, the handle 62 may be rotated by a user to a use position (FIGS. 5 and 6), where the handle 62 forms an angle relative to the front wall 55 of the door assembly 25 and has an enhanced viewability or is more easily viewed by the user. As the handle 62 is rotated, the latch assembly 60 unlatches the door assembly 25 permitting it to be opened by rotation of the door about a hinge axis along an interface between the bottom of the door and the cabinet 12. This unlatching occurs at an intermediate or second position between the latched position and the use position.

During the movement of the handle 62 from the intermediate position toward either of the latched or use positions, the tension in the cable 124 will urge the handle 62 to the latched position and use position, respectively. This means that when a user releases the handle 62 after moving it beyond the intermediate position, the over-center device 120 aids in retaining the handle 62 at the 35 degree rotation so that the user may access the user interface 70. Alternatively, if the handle 62 is not rotated to the intermediate position, the over-center device returns the handle 62 to the latched position.

The details of the door opening in response to the rotation of the handle 62 from the latched position to the use position are best described with reference to FIG. 7. The handle 62 may be rotated from the latched position, in the direction indicated by arrow 114, to either an unlatched position (phantom lines) or a use position (solid lines), either of which results in movement of the push rods 99 to rotate the door assembly 25 from the closed position to an opened position.

More specifically, as the handle 62 rotates to the unlatched position, the tips 98 of the arms 97 advance toward the push rods 99 to extend the push rods 99 into contact with the wash tub 14, which results in the compression of the springs 108 between the tabs 106 and the inner door panel 50. The extension of the push rods 99 advances the ends 104 into contact with the frame of the wash tub 14 and the push rods 99 apply a force between the door assembly 25 and the wash tub 14 to overcome the force required to unlatch the door assembly 25. The push rods 99 urge the door assembly 25 away from the wash tub 14, thereby moving the door assembly 25 to a position where it is slightly opened relative to the wash tub 14.

In the illustrated structure, the handle 62 and arms 97 rotate through about 25 degrees of rotation to effect the extension of the push rods 99, which corresponds to the handle 62 being pivoted to the intermediate or unlatched position. Further rotation of the handle 62 from the intermediate position to the use position (also referred to as the third position) does not further extend the push rods 99 because of the rotation control provided by the multi-pivot linkages 90, which effectively uncouple the rotation of the handle 62 and the arms 97 when the handle 62 is rotated between the intermediate and use positions. Thus, the rotation of the handle 62 from the intermediate to use positions will not result in further rotation of the door assembly 25 relative to the wash tub 14 attributable to the extension of the push rods 99. In the use position, the handle 62 as illustrated is rotated about 35 degrees while the arms 97 remain at the 25 degrees of rotation. In the use position, the user interface is more easily viewed by a user than at the intermediate position.

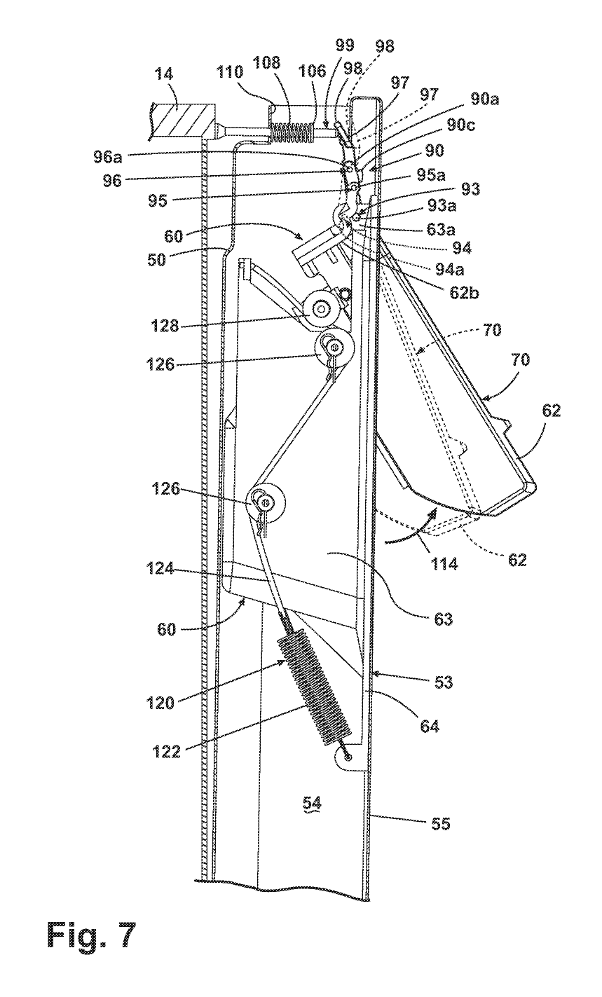

The operation of the multi-pivot linkages 90 limiting the relative rotation of the arms 97 to the handle 62 is best understood with reference to FIGS. 8A-8C. For orientation purposes, FIG. 8A illustrates the handle 62 in the latched position, FIG. 8B illustrates the handle 62 in the intermediate position or unlatched position, FIG. 8C illustrates the handle 62 in the use position.

As the handle 62 is rotated from the latched position (FIG. 8A) to the intermediate position (FIG. 8B), the handle bars 62a, 62b rotate about the axis 93c to the same degree that the arm 97 rotates about the axis 94c. The linking bars 90a and 90b acts to rotationally couple the arm 97 and the handle 62 such that the arm 97 rotates with the handle 62 until they have both been rotated approximately 25 degrees, after which further rotation of the handle 62 does not rotate the arm 97.

That the arm 97 does not further rotate can be seen as the handle 62 is moved from the intermediate position (FIG. 8B) to the use position (FIG. 8C). As the handle 62 is moved from the intermediate position (FIG. 8B) to the use position (FIG. 8C), the handle 62 rotates about the axis 93c. The linking bars 90a and 90b couples the arm 97 to the handle bars 62b, 62c such that further rotation of the handle 62 results in rotation of the linking bars 90a and 90b about both axes 95c and 96c, without any rotation of the arm 97 about axis 94c.

With this configuration, the two axes of rotation 95c, 96c effectively uncouple the rotation of the handle 62 from the arms 97 from the intermediate position to the use position. The rotation of the handle 62 from the intermediate position to the use position does rotate the handle bars 62b, 62c, but this rotation leads to a rotation of the linking bars 90a and 90b about the axes 95c, 96c, which lets the arm 97 stay stationary. The arm 97 makes up one of the bars of the four-bar linkage. The linking bars 90a and 90b, handle 62, and housing 63 make up the remaining bars of the four-bar linkage.

Such rotation controllers as the multi-pivot linkages 90 are useful when the door compartment 54 is not wide enough to accommodate the desired range of rotation of the handle 62. Although the thinner door assembly 25 does not allow for the handle 62 to be rotated 35 degrees without such a rotation controller, the thinner door assembly 25 does allow a larger wash tub to be put inside the chassis. A larger wash tub is desirable in that it provides larger capacity for utensils, which allows for more utensils to be washed at one time. This results in a saving of both time and energy as the dishwasher 10 needs to be run fewer times to wash the same amount of utensils.

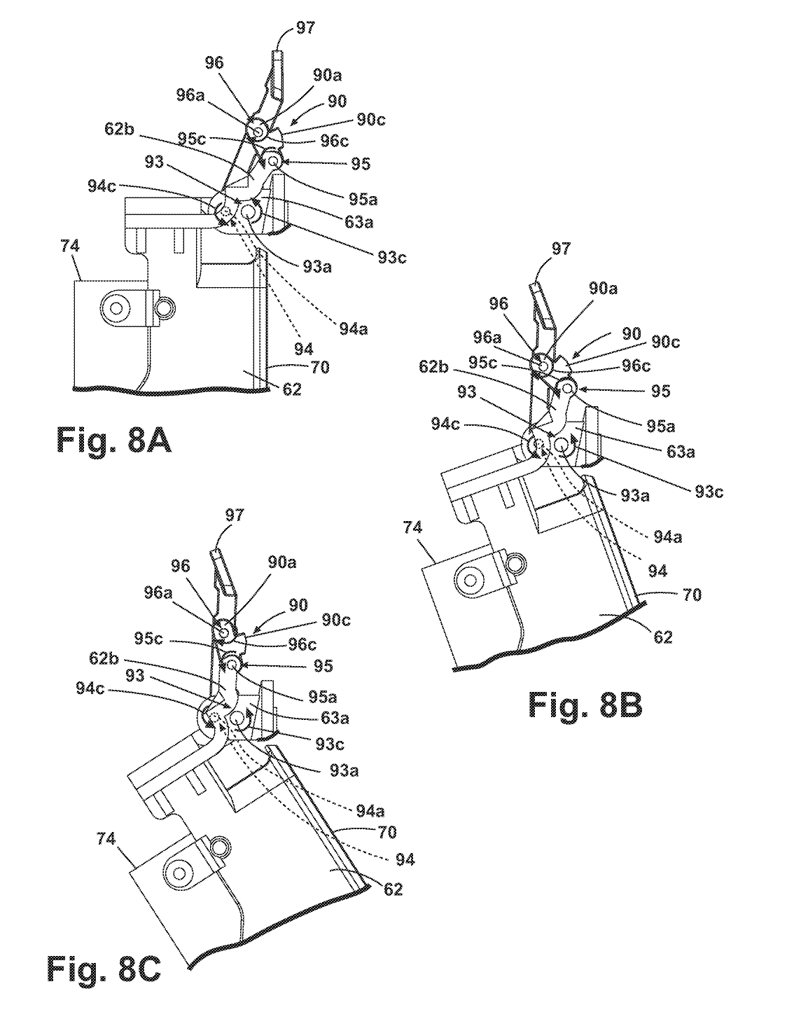

FIG. 9 illustrates a second example of a rotation controller or multi-pivot linkage 150 which may be used in the latch assembly 60. The rotational reducer 150 differs from the multi-pivot linkage 90 primarily in that the linking bars 90a, 90b are replaced with a modified linking bar 150a, having a lower and upper set of openings 152, 154, and the arm 97 is slightly modified as arm 197. Therefore, similar structure between the two rotational reduces will use the same numerals, with it being understood the prior description is applicable to the multi-pivot linkage 150.

The rotation reducer 150 is illustrated as including handle bars 62b and 62c, a pair of housing bars 63a and 63b, and the linking bar 150a. The linking bar 150a couples the arm 97 to the handle 62 such that a 35 degree rotation of the handle 62 may be achieved with only a 25 degree rotation of the arm 97. A pivot joint 156 rotationally couples the linking bar 150a and the arm 97 to the housing bars 63a, 63b by a pivot pin 158 to define a pivot axis 156a about which the linking bar 150a and arm 97 may pivot. The pivot pin 158 is received in corresponding holes defined in the housing bars 63a and 63b and the arm 97, and in the lower set of openings 152 to couple the housing bars 63a and 63b, the arm 97, and the linking bar 150a together.

Another pivot joint 160 rotationally couples the linking bar 150a and the handle bars 62b and 62c to each other, without coupling to the arm 97 as with the rotational reducer 90. The handle bars 62b and 62c are coupled to the linking bar 150a at a pair of pivot joints 160 by a pair of pivot pins 162. The pivot pins 162 are received in corresponding holes defined in the handle bars 62b and 62c and the upper set of openings 154 to couple the handle bars 62b and 62c with the linking bar 150a.

As the user rotates the handle 62, the arm 97 rotates with the handle 62 until it contacts a stop 168 formed on a lower portion of the linking bar 150a. The stop 168 limits the relative rotation of the arm 97 while the handle 62 is free to rotate further. This also correlates to the arm 97 rotating with the handle 62 until the arm 97 advances the push rod 99, after which further rotation of the handle 62 does not rotate the arm 97. This corresponds to the arm 97 and the handle 62 rotating together for approximately 25 degrees. Then the arm 97 remains stationary while the linking bar 150a and the handle 62 continue to rotate about an axis 160a until the handle 62 has rotated to about 35 degrees to the use position.

The multi-pivot linkage 150 allows for a full rotation of the handle 62 to the use position while limiting the motion of the arm 97 so that the rotation of the arm 97 is accomplished within the space of the door compartment 54. In this manner, the multi-pivot linkage 150 includes a two-state linkage. The two-state linkage forms at least two axes 156a, 160a of rotation providing for the relative rotation of the handle 62 and the arm 97.

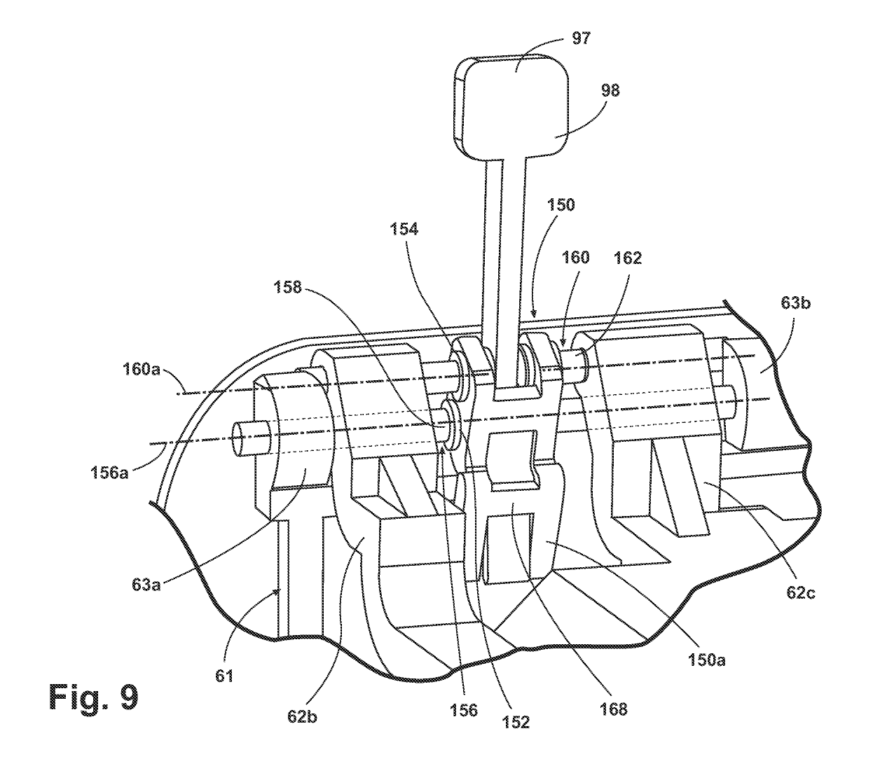

FIGS. 10A-10C schematically illustrate the two-state linkage between the arms (numbered 97 for simplicity), the handle 62, and the linking bar 150a and movement thereof. FIG. 10A shows the linkage before any rotation has occurred. FIG. 10B illustrates that the arm 97 and handle 62 rotate together for approximately 25 degrees at which point the movement of the arm 97 is stopped. Finally, FIG. 10C illustrates that the arm 97 remains stationary while the linking bar 150a and the handle 62 rotate until the handle 62 reaches a rotation of 35 degrees.

Both of the rotational controllers control the range of motion for the rotation of the handle to the predetermined maximum angle. The predetermined maximum angle for the purposes of the illustrated appliance is approximately 35 degrees relative to the plane of the door, such that the angle at which the user interface 70 is oriented is easy for the user to view. The best viewing angle may vary depending on the configuration of the appliance.

Such rotation controllers are useful when the door compartment 54 is not wide enough to accommodate the desired range of rotation of the handle 62. Although the thinner door assembly 25 does not allow for the handle 62 to be rotated 35 degrees without such a rotation controller, the thinner door assembly 25 does allow a larger wash tub to be put inside the chassis. A larger wash tub is desirable in that it provides larger capacity for utensils, which allows for more utensils to be washed at one time. This results in a saving of both time and energy as the dishwasher 10 needs to be run fewer times to wash the same amount of utensils.

Regardless of the rotational controller used, the user interface 70 is operably coupled to the handle 62 such that when the handle 62 is pivoted relative to the door assembly 25 the user interface 70 is also rotated and the normal plane of the user interface 70 is oriented at an angle relative to the door assembly 25. As illustrated, when the handle 62 is pivoted relative to the door assembly 25 the secondary controller 74 is also rotated.

Pivoting the handle 62 until the user interface 70 is oriented at an angle relative to the door assembly 25 may including pivoting the handle 62 at least to a position necessary to unlatch the door assembly 25. The handle 62 may be rotated beyond the position necessary to unlatch the door assembly 25 to some predetermined maximum angle, of approximately 35 degrees, such that the angle at which the user interface 70 is oriented at relative to the door assembly 25 is acute. When the handle 62 is pivoted from the stored position to a point where the normal plane of the user interface 70 is oriented at an acute angle relative to the front wall 55 of the outer door panel 53 it may be considered to be in a use position.

When the handle 62 is in the use position the user interface 70 is more easily viewable by a user. Thus, the predetermined maximum angle may correlate to an appropriate viewing angle for a user using the user interface 70. In this rotated position, the user interface 70 may be operated by the user and the latch assembly 60, handle 62, and user interface 70 may be considered to be in the use position.

The secondary controller 74 may be provided with software in the controller memory 76 which may be executed by the CPU 77 to only display on the touch screen 72 a variety of input/output screens based on the rotational position of the handle 62, as detected by the position sensor 78 (FIG. 1). For example, it is contemplated that the secondary controller 74 may only allow a user to operate the user interface 70 when the handle 62 is rotated to the use position. Thus, at least some inputs on the user interface 70 may be activated by the secondary controller 74 in response to its pivoting to the use position. For example, if the handle 62 is pivoted to the use position, the touch screen 72 may provide the user with the opportunity to input information to control the operation of the dishwasher 10 and may provide output to communicate information with the user. More specifically, the touch screen 72 may provide the user with the opportunity to input information with respect to a cycle selector, an option selector, and a cycle start selector.

Alternatively, it has been contemplated that the secondary controller 74 may allow a user to operate the user interface 70 when the handle 62 is pivoted at least to a position necessary to unlatch the door assembly 25, or an unlatched position. When the handle 62 is pivoted to the unlatched position, the touch screen 72 may provide the user with the opportunity to input information to control the operation of the dishwasher 10 and may provide output to communicate information with the user. In the examples above, the user may only select the cycle of operation and any options via the user interface 70 when the door assembly 25 is open and the handle 62 has been pivoted to its respective use position or unlatched position. Selecting the cycle of operation may include selecting a dishwashing cycle of operation. It has also been contemplated that power may only be provided to the user interface 70 in response to the pivoting of the handle 62 to at least one of the use position and the unlatched position.

When the handle 62 is in the use position, the secondary controller 74 may receive input from the user through the touch screen 72 and display visual outputs to the user in the form of graphics, texts, icons, video and any combination thereof. The touch screen 72 may receive input from the user based on tactile contact, such as by a user touching the touch screen 72 with an object, such as a finger. The secondary controller 74 may detect contact, including movement of the contact, on the touch screen 72 and convert the detected contact into interaction with the objects (graphics, texts, icons, etc. . . . ) displayed on the touch screen 72. The secondary controller 74 may be programmed to detect contact and movement of a contact according to any known methodology.

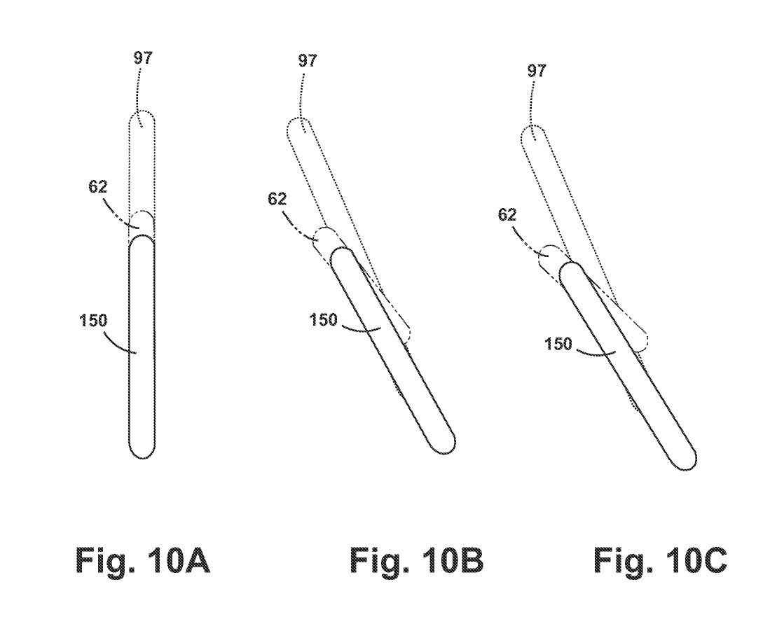

FIG. 11 illustrates a non-limiting example of what the touch screen 72 may look like when the handle 62 has been pivoted to the use position. The touch screen 72 is illustrated as including a selection screen 80 that includes a cycle selector 81, an option selector 83 illustrated as a multitude of option buttons which may be selected or deselected with respect to each cycle, a help button 84, a start button 85 to start a cycle of operation, a delay button 86, and a lock button 87. It is within the scope of the invention for the touch screen 72 to have any shape and to display output such as icons or text to navigate away from the selection screen, to adjust other parameters of the operating cycle, to select a specific zone in the dishwasher 10, to select an operating cycle for a zone in the dishwasher.

As illustrated, the cycle selector 81 is illustrated as scroll bar 82 having a plurality of available user-selectable cycles from which a user may select a desired cleaning cycle. Exemplary cycles include ProWash, Pots/Pans, Normal Wash, China Gentle, Fast Wash, and Quick Rinse. During the ProWash mode, the cleaning level and cycle time may be automatically selected based on a size of the dish load and a soil level of the dish load. The Pots/Pans mode may be utilized for hard-to-clean and heavily soiled pots, pans, and other utensils, the Normal Wash mode may be employed for dish loads with a normal amount of food soil, and the China Gentle mode may be suited for lightly soiled items or china and crystal. The Fast Wash mode quickly washes dish loads that are pre-rinsed, and the Quick Rinse mode rinses dish loads that will not be washed immediately.

The secondary controller 74 may be provided with software in the controller memory 48 which may be executed by the CPU 49 to sequentially display on the touch screen 72 and navigate through a variety of input/output screens based on the user input received from the touch screen 72. Each input/output screen may provide the user with the opportunity to input information to control the operation of the dishwasher 10 and may provide output to communicate information with the user. For example, based on the cycle selected by the user, additional input/output screens may be displayed in which the user may modify the selected cycle by adjusting one or more operating parameters or by providing input upon which the main controller 47 may automatically modify the selected cleaning cycle. Each subsequent input/output screen displayed to the user on the touch screen 72 may be based on user input from the previously displayed input/output screen. For example, the options shown by the option selector 84 may vary depending on the cycle selected through the cycle selector 80. Exemplary options include High Temp, Sani Rinse, and Pro Dry. The High Temp option increases the water temperature during wash portions of the cycle, the Sani Rinse option raises the water temperature in a final rinse portion of the cycle, and the Pro Dry option dries the dish load with heat.

It has been contemplated that when the user presses the start button 85, a message will be displayed on the touch screen 72 asking the user to close the door assembly 25 within 3 seconds. The cycle will only begin after the start button 82 has been pressed and the door assembly 25 has been closed. It has been contemplated that when the door assembly 25 is in the closed position the latch assembly is also in the latched position and the user interface 70 may not be operated by the user. However, when the latch assembly 60 is in the latched position, the user interface 70 may still be powered such that the touch screen 72 may provide output to communicate information with the user. In such a state the touch screen may not provide the user with the opportunity to input information but will only display a status of the dishwasher 10.

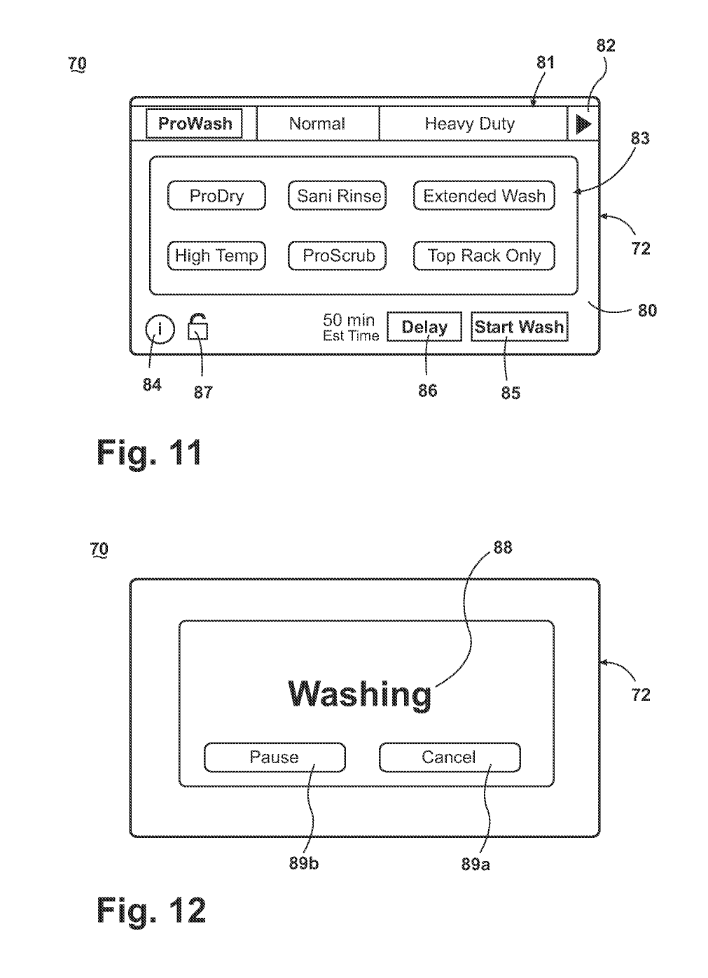

FIG. 12 illustrates a non-limiting example of such a status display on the user interface 70. As illustrated the user interface 70 may include a status indicator 88, which may communicate to the user during the implementation of the cycle of operation to provide an operating status of the cycle. For example, the mode status indicator may include visual indicators to inform the user when the cycle of operation may be at a washing stage or a drying stage, or when the dish load may be clean upon completion of the selected cycle of operation. Additionally, the status indicator may communicate to the user when the dish load may be sanitized after completion of the selected cycle of operation with the Sani Rinse option.

Alternatively, when the latch assembly 60 is in the latched position the touch screen 72 may provide the user with the opportunity to input information to control the cessation of the cycle of operation. For example, the touch screen 72 may provide the user with the opportunity to input information with respect to the ceasing the cycle in the form of a cycle cancel selector 89a and cycle pause selector 89b. After the cycle is complete, the touch screen 72 may display a message alerting the user that the utensils are clean.

It has also been contemplated that opening and closing the door assembly 25 may cause the secondary controller 74 to display various messages on the touch screen 72 and navigate through a variety of input/output screens based on the user input received from the touch screen 72. For example, on opening the door and closing the door assembly 25, the touch screen 72 may display a message asking the user if the utensils are dirty. If the user selects that they are dirty, the screen displays a message that the utensils are dirty. Alternatively, if no action is taken and the user does not select that the utensils are dirty, after three seconds, the screen may go back to displaying a message that the utensils are clean. In this manner the clean or dirty status of the utensils may be displayed on the touch screen 72 when the door assembly 25 is closed.

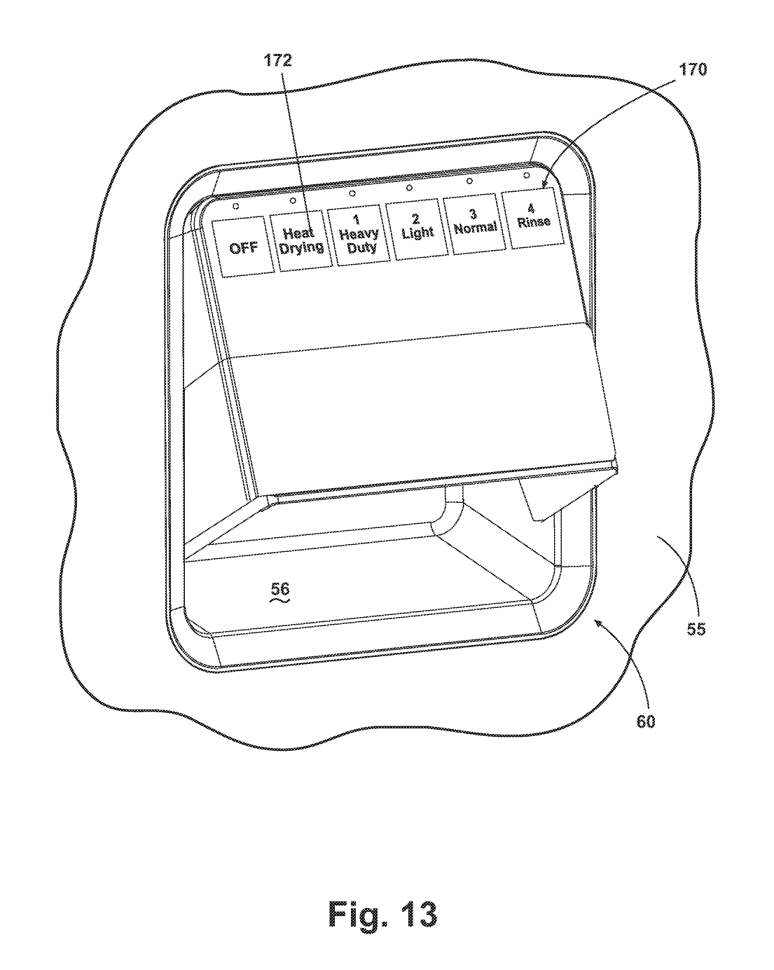

FIG. 13 illustrates a fourth embodiment of the latch assembly 60, which includes a user interface 170 which is similar to the first user interface 70 except that the user interface 170 has capacitive touch buttons 172 instead of a touch screen.

Typical dishwashers provide the user interface on the front of the door or the top of the door. These locations do not provide a satisfactory viewing angle for the user. The apparatuses described above allow a user to move the user interface to an angle at which it is easier to see and use the user interface.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims. For example, while the invention is described in the context of a touch screen through which the user may directly interact with the selection screen, it is also within the scope of the invention for the user to interact with the selection screen indirectly using any other suitable type of input mechanism, non-limiting examples of which include a mouse, a track ball, a joystick, a dial and one or more buttons or keys.

What is claimed is:

1. A method of operating an appliance having a treating chamber selectively accessible by a moveable door having a pivoting handle, where an article may be received in the treating chamber for treatment according to a cycle of operation stored in a controller and which is selectable by a user via a user interface coupled to the controller, the method comprising:
providing the user interface on the handle, with the user interface defining a normal plane; and
pivoting the handle relative to the door such that the normal plane of the user interface is oriented at an angle relative to the door.

2. The method of claim 1 wherein the angle is an acute angle.

3. The method of claim 2 wherein the pivoting comprises pivoting the handle from a stored position, where the normal plane of the user interface is substantially parallel with a face of the door, to a use position, where the normal plane of the user interface is oriented at an acute angle relative to the face of the door.

4. The method of claim 1, further comprising activating at least some inputs on the user interface in response to its pivoting.

5. The method of claim 4 wherein the at least some inputs comprise at least one of: a cycle selector, option selector, and cycle start selector.

6. The method of claim 4, further comprising activating only cycle ceasing inputs of the user interface prior to pivoting.

7. The method of claim 6 wherein the cycle ceasing inputs comprise at least one of: a cycle cancel selector and cycle pause selector.

8. The method of claim 1, further comprising providing power to the user interface in response to the pivoting of the handle.

9. The method of claim 1, further comprising selecting the cycle of operation via the user interface only after the pivoting.

10. The method of claim 9 wherein the selecting the cycle of operation comprises selecting a dishwashing cycle of operation.

11. The method of claim 1 wherein the pivoting the handle comprises pivoting the handle at least to a position necessary to unlatch the door.

12. The method of claim 11 wherein the pivoting of the handle beyond the position necessary to unlatch the door, to a position of enhanced viewability, does not further move the door.

13. The method of claim 11, further comprising activating at least some inputs on the user interface in response to pivoting the handle at least to a position necessary to unlatch the door.

14. A dishwasher comprising:
a chassis defining an interior;
an open-faced tub located within the chassis;
a door movably mounted to the chassis for movement between opened and closed positions to selectively open and close the open face of the tub and having an exterior face;
a latch assembly mounted to the door and comprising:
a handle pivotally movable relative to the door between a latched position, where the handle is substantially parallel to the exterior of the door, and an unlatched position, where the handle forms an angle relative to the exterior face of the door; and
a user interface mounted to the handle and having an enhanced viewability by a user when the handle is in the unlatched position.

15. The dishwasher of claim 14 wherein the latch assembly further comprises a controller operably coupled to the user interface.

16. The dishwasher of claim 15, further comprising a position sensor operably coupled to the controller for communicating at least one position of the handle to the controller.

17. The dishwasher of claim 15 wherein the controller is mounted to an obverse side of the handle from the user interface.

18. The dishwasher of claim 14 wherein the user interface is flush with the exterior face of the door.

19. The dishwasher of claim 14 wherein the latch assembly further comprises at least one push rod, which a portion of the handle contacts and advances into contact with the tub when the handle is pivoted to the unlatched position.

20. The dishwasher of claim 19 wherein the latch assembly further comprises at least one arm coupled to the handle that abuts the at least one push rod to advance it into contact with the tub when the handle is pivoted to the unlatched position to move the door to the opened position.

21. The dishwasher of claim 20 wherein the latch assembly further comprises a rotation reducer coupling the arm to the handle such that the arm is rotated a lesser amount than the handle.

22. The dishwasher of claim 21 wherein the rotation reducer rotationally couples the arm and the handle such that the arm rotates with the handle until the arm advances the push rod, after which further rotation of the handle does not rotate the arm.

23. The dishwasher of claim 21 wherein the rotation reducer comprises a multi-pivot linkage providing at least two axes of rotation for the arm relative to the handle.

24. The dishwasher of claim 23 wherein the multi-pivot linkage comprises a four bar linkage forming at least three axes of rotation providing for relative rotation of the handle and the arm.

25. The dishwasher of claim 24 wherein the arm comprises one of the bars of the four bar linkage and two of the axes of rotation lie on the arm.

26. The dishwasher of claim 23 wherein the multi-pivot linkage comprises a two-state linkage forming at least two axes of rotation providing for relative rotation of the handle and the arm.

27. The dishwasher of claim 26, wherein the latch assembly further comprises a stop that limits the relative rotation of the arm, while the handle is free to rotate further.

28. The dishwasher of claim 14, wherein the handle is further pivotally movable beyond the unlatched position to a use position, wherein the handle forms a larger angle relative to the exterior face of the door and the user interface has enhanced viewability by a user.

29. The dishwasher of claim 28, further comprising an over-center device that biases the handle toward the use position when the handle is located anywhere between the unlatched position and the use position.

30. The dishwasher of claim 29, wherein the over-center device biases the handle toward the latched position when the handle is located anywhere between the unlatched position and latched position.

31. A dishwasher comprising:
a chassis defining an interior;
an open-faced tub located within the chassis;
a door movably mounted to the chassis to selectively open and close the open face of the tub and having an exterior face; and
a user interface pivotally mounted to the door for movement between a stored position, where the user interface is substantially parallel to the exterior of the door, and a use position, where the user interface forms an angle relative to the exterior face of the door.

32. The dishwasher of claim 31, further comprising a controller operably coupled to the user interface.

33. The dishwasher of claim 32, further comprising a position sensor operably coupled to the controller for communicating at least one position of the user interface to the controller.

34. The dishwasher of claim 33 wherein the user interface is flush with the exterior face of the door in its stored position.
